(19) United States
(12) Patent Application Publication
(10) Pub. No.: US 2023/0265950 A1
(43) Pub. Date: Aug. 24, 2023

(54) DEVICE FOR CONNECTING A GAS-CARRYING PIPE ELEMENT AND METHOD FOR CONNECTING A GAS-CARRYING PIPE ELEMENT

(71) Applicant: Argo GmbH, Gräfelfing (DE)

(72) Inventor: Jan ANDREAS, Wesel (DE)

(21) Appl. No.: 18/015,312

(22) PCT Filed: Jul. 7, 2021
(86) PCT No.: PCT/EP2021/068793

§ 371 Date: Jan. 9, 2023

(30) Foreign Application Priority Data
Jul. 8, 2020 (DE) 10 2020 208 552.8

(51) Int. Cl. F16L 23/16; F16L 23/00; F16L 23/026; F16L 23/22

(52) U.S. Cl. CPC F16L 23/167; F16L 23/006; F16L 23/026; F16L 23/22; F16L 2201/30

(57) ABSTRACT

The present invention relates to a device 100 for connecting a gas-conducting conduit element 1, in particular a hydrogen-conducting conduit element, to a counterpart 2, in particular a component, comprising: at least one screw body 10, which is configured to be brought into tight engagement, in particular into gas-tight engagement, with the counterpart 2; a first seal 3, which is in the form of a valve body 3a which is configured to be brought into contact, in particular into gas-tight contact, with a valve seat 4 provided on the counterpart 2, or which is in the form of a flat seal; and a second seal 5 which operates on a sealing effect principle according to which the sealing effect is exerted or deployed irrespective of an axial displacement, in particular in an installation direction E, which is necessary for creating the sealing effect of the first seal 3.

### TECHNICAL FIELD

The present invention relates to a device for connecting a gas-conducting conduit element, in particular a hydrogen-conducting conduit element, to a counterpart, in particular to a component. Moreover, the present invention relates to a method for connecting a gas-conducting conduit element, in particular a hydrogen-conducting conduit element, to a counterpart, in particular to a component.

### PRIOR ART

Devices for connecting a gas-conducting conduit element, in particular a fluid conduit for compressed hydrogen, to a component, for example a component in which the gas is to be introduced, such as an on-tank valve (OTV), a gas handling unit (GHU), a gas pressure tank or other gas-conducting components, or even to a component formed as a coupling element of a different conduit element, are known from the prior art. Since sealing plays a decisive role in the case of gases, sealing members are typically used. This also applies in particular in the case of high-pressure applications such as in conduit elements for compressed natural gases or for compressed hydrogen. In particular when sealing hydrogen, appropriate sealing members that offer high diffusion resistance to the hydrogen are of vital importance.

DE 195 11 063 A1, for example, describes a pipe connection with a connecting body having a conical bore and a nut having a conical surface, wherein a connecting section is integrally formed on a pipe. The connecting section has clamping surfaces produced by way of compression, which have the same orientation as the corresponding conical bore and conical surface. During the manufacture of the connecting section the pipe was subjected to deformation with a specific compression path, which is to ensure that the connection does not set during mounting or repeated mounting and start leaking as a result.

Moreover, ferrule-type connection devices or adapters are well known, and normally comprise a threaded coupling nut, a threaded coupling body and one or more ferrules which are fitted inside the coupling nut. The coupling nut normally has a contact surface (surface of first contact), which is engaged with, or can be brought into engagement with, a contact surface on a ferrule. A cylindrical conduit, such as a pipe end, for example, is inserted into the coupling body, with the ferrules tightly or closely surrounding the outer wall of the conduit end. If the coupling nut is installed at the thread end of the coupling body, an axial force will be exerted on the ferrule or ferrules, which causes the contact surfaces of each of the ferrules and the body to engage such that a compressive effect is created, as a result of which a radial displacement of sections of the ferrules causes them to tightly hold the outer wall of the conduit end. In many applications, the adapter can be assembled using simple hand tools such as wrenches, for example.

In order to be able to use such screw connections in the field of aviation, for example, in which there are stringent requirements in terms of resilience including changes in temperature and load, as well as in terms of imperviousness, a so-called putty is frequently used in the prior art, which, once applied to and in the screw connection, requires a certain amount of curing time before further work can be carried out here. Furthermore, if leaks occur at this screw connection, it will be necessary to remove the screw connection and carry out time-consuming remedial work, and also to give the putty time to cure again. Use on a wing box of an aircraft, for example, is time-consuming owing to the small amount of space available, the narrow access and the considerable number of screw connections.

Furthermore, such screw connections are difficult to log, which is extremely important particularly in the field of explosion protection (ATEX), in vehicle manufacturing, in this case in particular in aircraft construction. Thus, methods and devices for assessing the properties of components of such mechanically applied connections have been proposed in the prior art. Properties that can be assessed include, inter alia, the position of a conduit holding device on a conduit, the amount of axial compression or displacement of the conduit holding device and the amount of clamping force exerted on the conduit holding device when the conduit holding device is axially compressed or displaced.

Such methods are extremely time-consuming and can only be carried out by trained staff. However, even when strict safeguards are in place, such methods are highly dependent on the respective test personnel and can still result in incorrect test results due to material and assembly errors.

On account of the alternating stress (changes in temperature and tension), leaks may occur, particularly in the field of automotive engineering, in this case in particular in the field of aircraft construction. Owing to the high number of screw connections and the disadvantages of conventional screw connections described above, this can lead to considerable maintenance and assembly work.

A further disadvantage of conventional connecting techniques for gas-conducting conduit elements is the fact that both the sealing members and the screw members that are used to create the sealing effect come into direct contact with the medium to be sealed, in particular the gas. This is not dramatic in the case of conventional gases such as natural gases, but it can be a major safety hazard in the case of compounds used for fluid conduits for hydrogen. Since many materials, in particular metals, are prone to so-called “hydrogen embrittlement” when they come into contact with hydrogen, this, in particular when combined with alternating stress (changes in temperature and tension) and vibrations, can often lead to leaks in the case of known connecting techniques. Since hydrogen is the lightest of all of the chemical elements, permanently sealed connection points are difficult to realise.

### DESCRIPTION OF THE INVENTION

In view of the above-described problems when connecting gas-conducting conduit elements, in particular hydrogen-conducting conduit elements, an object of the present invention is to provide a device and a method for connecting a gas-conducting conduit element to a counterpart which are able, firstly, to create a defined sealing situation which can be logged and thus certified and, secondly, to take into account the problems described above, such as hydrogen embrittlement and the occurrence of leakages caused by temperature and tension changes, as well as vibrations, and which at the same time facilitate a simplified design and therefore reduced assembly and maintenance work.

The aforementioned object is achieved by a device for connecting a gas-conducting conduit element, in particular a hydrogen-conducting conduit element, to a counterpart, in particular a component, as according to claim 1, as well as by a method for connecting a gas-conducting conduit element, in particular a hydrogen-conducting conduit element, to a counterpart, in particular to a component, as according to claim 16.

In this regard, one of the basic ideas of the present invention is to provide a device for connecting a gas-conducting conduit element preferably intended to conduct hydrogen, which device comprises two seals which are arranged one behind the other or in series in an outflow direction of a leaking or seeping gas and which operate on two different sealing effect principles. In this respect the first of the two seals, which is preferably disposed as the first one in the outflow direction, i.e. in front of a second of the two seals, is preferably formed as a seal which seals by way of a pressing force. The second seal, however, operates on a sealing effect principle according to which the sealing effect is exerted or deployed irrespective of an axial displacement, in particular in an installation direction E, which is necessary for creating the sealing effect of the first seal (pressing force).

In this way, the sealing of a device for connecting a gas-conducting conduit element to a counterpart can be provided, which on the one hand has a seal, namely the first seal, which can be logged and certified by way of predetermined parameters that can be easily measured and logged. The provision of the second seal additionally improves the sealing effect and, in particular, makes it possible that even in the unfortunate event of the first seal leaking, i.e. of gas escaping through the first seal, the second seal continues to seal the connection point in a gas-tight manner and therefore buys time for the first seal to be repaired before the gas actually escapes to the outside through the connection point. This is extremely advantageous, particularly in the field of explosion protection.

According to one aspect of the present invention, a device for connecting a gas-conducting conduit element, in particular a hydrogen-conducting conduit element, to a counterpart, in particular a component, comprises: at least one screw body, which is configured to be brought into tight engagement, in particular into gas-tight engagement, with the counterpart; a first seal, which is in the form of a valve body which is configured to be brought into contact, in particular into gas-tight contact, with a valve seat provided on the counterpart, or which is in the form of a flat seal; and a second seal which operates on a sealing effect principle according to which the sealing effect is exerted or deployed irrespective of an axial displacement, in particular in an installation direction, which is necessary for creating the sealing effect of the first seal.

The present device relates to a so-called “mechanically applied connection”, such as, for example, connector pieces, joining pieces, couplings, assembly pieces, valve inlets and outlets, valve connections and the like, which are used in fluid systems or fluid circuits such as hydrogen supply systems in vehicles and which have a fluid flow and a fluid pressure. Such mechanically applied connections may be used with conduit connection pieces for a pipe, a tube or any other type of conduit, but they are not limited thereto, and they connect a conduit end to any other conduit end or to a different section, element or component of a fluid system, such as a valve housing. Such mechanically applied connections are characterised by a fluid-tight (gas-tight) seal as well as by mechanical strength, for holding the connection together, including a sufficient hold of the conduit in the event of vibrations, stress and pressure.

In this respect it may be advantageous for the first seal to be formed as a so-called metal seal or curved-surface seal, and/or for the second seal to be formed as a radial seal, a resilient seal, an O-ring, a delta ring, a liquid seal and the like, and/or for the second seal 5 to be disposed after the first seal in an outflow direction of a gas flowing out from the gas-conducting conduit element which is leaking or seeping through the first seal.

A metal seal is understood to mean that two elements made of metal are pressed against each other under the influence of force, such that a fluid-tight connection is created between the two elements. In such a case, an annular contact surface is usually created between the two elements, through which the medium or gas to be sealed can flow.

Furthermore, it is advantageous if the valve body has an at least partially conical shape, rounded shape, spherical shape or globular shape, and/or if the valve seat provided in the counterpart has a tapered shape, in particular a conical shape.

Moreover, it is preferred that the first seal is formed at an end face of the screw body, in particular at an end face of the screw body which descends into a recess of the counterpart (in the assembled or gas-tight connected state) formed complementarily to the screw body, and/or that the second seal is provided or formed on a peripheral surface of the preferably cylindrical screw body, which preferably faces an inner wall of the recess formed in the counterpart in the installed state.

According to a further embodiment, the valve body and the valve seat are configured in such a manner that an annular contact surface is formed, with a central axis of the valve seat and a central axis of the valve body being disposed parallel to one another, in particular coaxially to one another, and the valve body being displaceable parallel to the two central axes, in particular in an installation direction.

Moreover, it is preferred that the device also has at least one fluid channel having an open end which is provided between the first seal and the second seal and which is configured to detect a gas flowing out from the gas-conducting conduit element which is leaking or seeping through the first seal.

In this regard, “detect” is to be understood such that the fluid channel allows the leaking gas to be received by the fluid channel and to flow through it. In this way, the leaking gas can be guided to a downstream gas sensor, which can detect the leaking gas and signal the presence of a leak.

Moreover, it is preferred that the at least one fluid channel is formed in the screw body and/or in the counterpart. If the fluid channel is formed in the screw body, an autonomous unit with leakage detection means can be formed, as a result of which, however, the costs of the individual devices (connection devices) will rise, but this may nevertheless be advantageous in certain applications. If on the other hand the fluid channel, or sniffer channel, is integrated into the counterpart, in particular into a component such as a gas handling unit (GHU), a plurality of sealing points or connection points can be channelled to a sensor chamber, as a result of which a plurality of sealing points can be monitored by a single sensor.

Furthermore, it may be advantageous if the device, in particular the screw body, is configured to perform a purely translatory movement, in particular in the installation direction, during the creation of the gas-tight connection between the screw body and the counterpart. In other words, the device is configured such that no rotational movement of the screw body relative to the counterpart occurs or is necessary during the connection, in particular the gas-tight connection by way of two seals arranged in series, of the gas-conducting conduit element to the counterpart. This makes installation easier, in particular in the case of long conduit elements and conduit elements provided with a plurality of bends. This constitutes a major advantage over known screw connections, which, in most cases, are screwed into a counterpart via an external thread.

In this regard the screw body can advantageously be provided with at least two, preferably four, through-holes for receiving fastening screws, the through-holes preferably being provided on a flange projection of the screw body, and the through-holes preferably being disposed behind the two seals in an outflow direction of a gas flowing out from the gas-conducting conduit element which is leaking through the first seal.

Furthermore, the device may comprise a third seal, which is formed as a radial seal, a resilient seal, an O-ring, a delta ring, an elastomeric sealing member, a liquid seal and the like, the third seal being disposed after the first seal or after the second seal in an outflow direction of a gas flowing out from the gas-conducting conduit element which is leaking through the first seal.

According to a further embodiment of the present invention, the device further comprises a second fluid channel having an open end which is provided between the second seal and the third seal and which is configured to detect a gas flowing out from the gas-conducting conduit element which is leaking through the first seal and through the second seal.

It is also advantageous if the gas-conducting conduit element is connected in a gas-tight manner to the screw body by way of a welding connection. In this way, a further possible leakage site, namely the connection point between the conduit element and the screw body, can be avoided and once the welding has been performed, a leak test can be carried out, which can also be logged.

Moreover, it is advantageous if, in the sealed state, the valve body of the first seal is pressed against the valve seat formed in the counterpart via a screw connection, in particular at least two, preferably four, clamping screws.

In this way, a device or screw connection can be realised, wherein, with a predetermined tightening torque of the clamping screws, a relatively precise pressing of the valve body against the valve seat can be realised, such that a sealing contact of the corresponding elements can be ensured over a wide temperature range, and logging and thus certification is possible using the applied tightening torques.

According to a further embodiment of the present invention, the valve body, in particular the screw body, and/or the valve seat is made from a metal, in particular a steel material, preferably a stainless steel material, with the valve seat preferably being made of a harder material than the valve body.

If the valve seat is made of a harder material than the valve body, it can be ensured that in the event of a possible plastic deformation when pressing the valve body against or into the valve seat, the valve body will plastically deform, which can easily be replaced. In this way, the valve seat of the counterpart, which may be a valve seat provided in a complex valve unit such as a gas handling unit, can be protected against plastic deformation.

Furthermore, it is advantageous if the at least one fluid channel, preferably at least two fluid channels, can be channelled into a common sensor chamber in which a gas sensor for detecting gas is disposed. In this way, both seals can be monitored using a common sensor and a corresponding leakage detection device.

Alternatively, there is also the possibility that the two fluid channels can be routed into separate sensor chambers, where any escaping gas can be detected independently of one another.

The device according to the invention for connecting a gas-conducting conduit element to a counterpart can therefore be realised in a very simple and cost-effective manner and advantageously facilitates logging and certification. It is therefore particularly suitable for sealing in systems in which hydrogen, in particular compressed hydrogen, or compressed natural gas is used. Such systems, which are exposed to particularly high temperature fluctuations, tension fluctuations and vibrations, are found in particular in vehicles in which, for example, hydrogen at pressures of up to 700 bar or natural gas at typically 260 bar is used as fuel to power the vehicle, for example via a fuel cell.

In the context of the present invention, the term “vehicle” or “means of transport” or other similar terms includes motor vehicles in general, such as passenger vehicles including sports utility vehicles (SUVs), buses, lorries, various commercial vehicles, water vehicles including various boats and ships, aircraft, aerial drones and the like, hybrid vehicles, electric vehicles, plug-in hybrid electric vehicles, hydrogen vehicles and other alternative vehicles. As stated herein, a hybrid vehicle is a vehicle with two or more energy sources, for example, petrol-powered and simultaneously electric-powered vehicles.

The present invention also relates to a method for connecting a gas-conducting conduit element, in particular a hydrogen-conducting conduit element, to a counterpart, in particular to a component, preferably using the device described above, the method comprising: inserting a screw body into a complementarily formed recess of the counterpart, tightly screwing the screw body to the counterpart by means of a screw connection, wherein: a first seal is brought into a sealed state, in particular by pressing a valve body of the first seal against a valve seat provided in the counterpart, in particular in the recess, and a second seal, which operates on a sealing effect principle according to which the sealing effect is exerted irrespective of an axial displacement, in particular in an installation direction, which is necessary for creating the sealing effect of the first seal, is brought into a sealed state, in particular between the screw body and the recess.

Moreover, it is preferable if the method comprises a leakage detection step, wherein an open end of a fluid channel is disposed between the first seal and the second seal and the other end of the fluid channel opens into a sensor chamber in which a gas sensor is disposed; if now a leak is present at the first seal, the leaking gas flowing or leaking out from the first conduit element flows into the fluid channel and through this into the sensor chamber, wherein the gas sensor detects the gas, in particular the hydrogen, flowing into the sensor chamber and thus detects and signals a leak at the first seal.

In this respect, “signals” is to be understood to mean that the gas sensor sends a signal to a control, in particular a vehicle control, to communicate the fact that a leaking gas has been detected and that there is therefore a leak at the monitored seal or screw connection. This can then be communicated to a display, for example via the control, which display then illuminates or shows a corresponding warning signal.

As already indicated above, the device for connecting a gas-conducting conduit element, in particular a hydrogen-conducting conduit element, to a counterpart, in particular a component, can be used for the described method of connecting a gas-conducting conduit element to a counterpart. The further features disclosed in connection with the above description of the device can therefore also be applied to the method. The same is true in reverse for the method.

### BRIEF DESCRIPTION OF THE DRAWINGS

Further features and advantages of a device, a use and/or a method are set out in the following description of embodiments with reference to the accompanying drawings. In these drawings:

FIG. 1 schematically shows a known device for connecting a gas-conducting conduit element to a counterpart, and

FIG. 2 simplifies an embodiment of a device according to the invention for connecting a gas-conducting conduit element to a counterpart.

### DESCRIPTION OF EMBODIMENTS

Identical reference numbers that are used in different figures designate identical, corresponding or functionally similar elements.

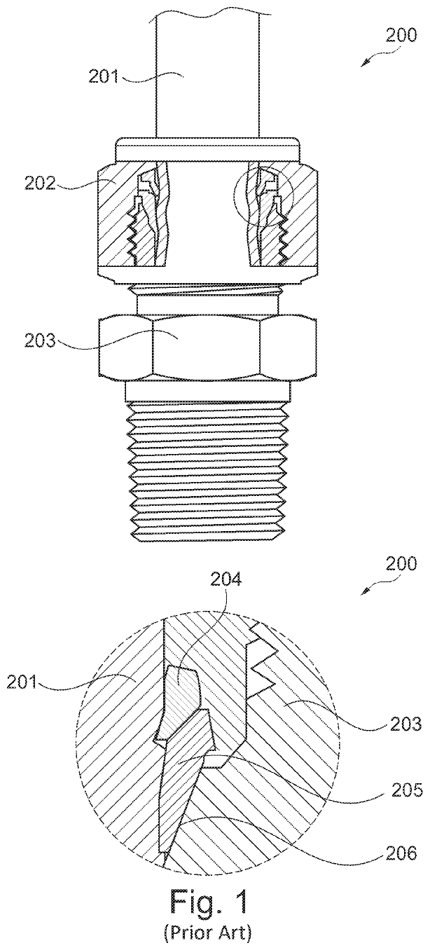

FIG. 1 schematically shows a known device 200 for connecting a gas-conducting conduit element 201 to a counterpart (not shown). The connection device shown in FIG. 1 is a ferrule-type connection device. As shown, such connection devices 200 comprise a threaded coupling nut 202, a threaded coupling body 203 and one or more ferrules 204, 205 which are fitted inside the coupling nut 202. The coupling body 203 normally has a contact surface 206 which is engaged with, or can be brought into engagement with, a contact surface on a ferrule. A cylindrical conduit, such as a pipe end of the gas-conducting conduit element 201, is inserted into the coupling body 203, with the ferrules 204, 205 tightly or closely surrounding the outer wall of the conduit end. If the coupling nut 202 is installed at the thread end of the coupling body, an axial force will be exerted on the ferrules 204, 205, which causes the contact surfaces of each of the ferrules and the body to engage such that a compressive effect is created, as a result of which a radial displacement of sections of the ferrules 204, 205 causes them to tightly hold the outer wall of the conduit end 201. In many applications, the adapter can be assembled using simple hand tools such as wrenches, for example.

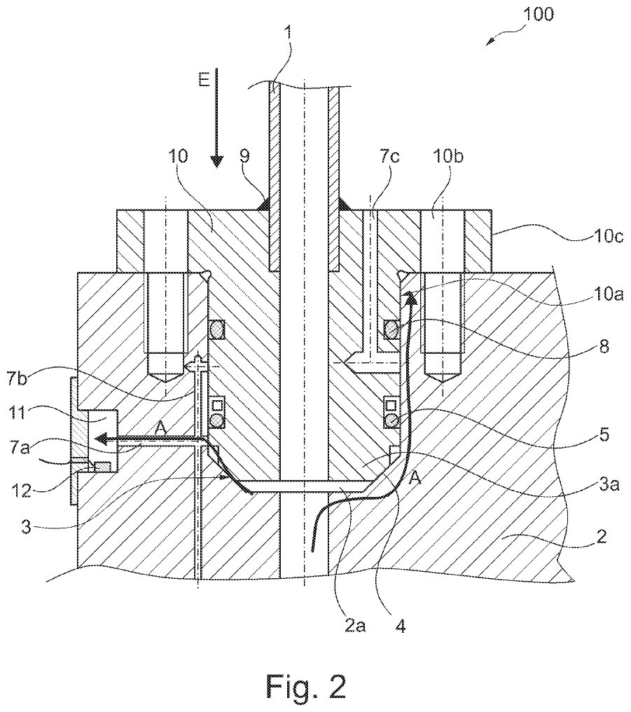

FIG. 2 shows in a simplified manner an embodiment of a device 100 according to the invention for connecting a gas-conducting conduit element 1 to a counterpart 2, wherein the embodiment shown is a part of a valve block, such as a gas handling unit, for example. As can be seen from FIG. 2, the device 100 shown consists of a cylindrical screw body 10 which extends longitudinally along an installation direction E. In the embodiment shown, the conduit element 1 to be connected is welded onto an end face of the screw body 10 facing the counterpart 2; as shown, the welding seam 9 is formed so as to be slightly larger to ensure that it is gas-tight.

Furthermore, the screw body 10 comprises a flange projection 10c on the end face facing the counterpart 2, which projection is provided with four through-holes radially spaced in the peripheral direction, in particular spaced at an angle of 90° to one another. As can also be seen from FIG. 2, the counterpart 2 comprises four complementarily arranged threaded holes, with which the screw body 10 can be screwed against the counterpart 2 by means of four clamping screws and fastened thereto.

A valve body 3a, which forms a part or region of the screw body 10, is formed on the other end face, i.e. the end face facing the counterpart 2, of the screw body 10. In the embodiment shown here, the valve body 3a is formed so as to have a conical shape.

The counterpart 2 is formed with a recess 2a, which has a complementary shape to the cylindrical shape of the screw body 10, in particular a cylindrical shape, and forms a clearance fit with said screw body 10 when the screw body 10 is introduced or inserted. At the bottom or inner end of the recess 2a a valve seat 4 is formed, which has a conical shape so as to be complementary to the valve body 3a, wherein the precise contour, angle and the like of the two elements 3a, 4 depend on the application in question, in particular the relevant operating pressure, the materials of the two elements and the like. The valve body 3a could also be formed so as to be arched or globular. What is important is that an annular contact surface is formed between the two elements.

As can also be seen from FIG. 2, the screw body 10 comprises two annular circumferential grooves provided on the cylindrical peripheral surface 10a, in which O-rings are inserted as the second and third seals 3, 5, in particular resilient seals, and abut against a cylindrical inner wall of the recess 2a of the counterpart 2 in a gas-tight manner.

If the screw body 10 is now inserted into the recess 2a and is fastened to the counterpart 2 by means of clamping screws, the valve body 3a is pressed against the valve seat 4, as a result of which a gas-tight connection or a gas-tight seal (first seal) is formed between the valve body 3a and the valve seat 4; this is also referred to as a metal seal. Two additional seals (so-called safety seals) are provided by means of the second and third seals, which are only used in the event that the first seal 3 forms a leak. In other words, the second and third seals 5, 8 only have to provide a sealing function in the event that the first seal starts to leak. Accordingly, the second seal 5 and the third seal 8 are disposed behind the first seal in an outflow direction A of a gas leaking through the first seal 3. In other words, the second and third seals 5, 8 are disposed so as to be axially spaced from the first seal 3 in a direction counter to the installation direction E.

Furthermore, FIG. 2 shows two fluid channels 7a, 7b which each have an open end, wherein the open end of the first fluid channel 7a is disposed between the first and second seals 3, 5 and the open end of the second fluid channel 7b is disposed between the second and third seals 3, 5. These two open ends of the fluid channels 7a, 7b each abut against the inner surface of the recess 2a of the counterpart 2. The two fluid channels 7a, 7b may lead to separate sensor chambers 11, in each of which a gas sensor 12 is arranged (not shown). In this way, it can be determined independently of the other whether only the first seal 3 (fluid channel 7a) is leaking or whether the first and second seals 3, 5 (fluid channel 7b) are leaking. In the embodiment shown, however, both fluid channels 7a, 7b are routed into a common sensor chamber 11, so that only one gas sensor has to be provided in order to be able to detect a leak at the two seals 3, 5. This constitutes an advantageous variant.

Finally, FIG. 2 also shows that the screw body 10 can optionally also be provided with a fluid channel 7c. In this case, the open end of the fluid channel 7c is disposed between the second and third seals 5, 8, and therefore it is only possible to detect a leak if both seals (the first and second seals 3, 5) are leaking (in the event that the two fluid channels 7a, 7b are not provided).

It will be obvious to a person skilled in the art that individual features described in the different embodiments can also be implemented in a single embodiment provided they are not structurally incompatible. Similarly, the different features described in the context of a single embodiment can also be provided in a plurality of embodiments individually or in any suitable sub-combination.

### LIST OF REFERENCE NUMBERS

100 Device (screw connection)
1 Conduit element
2 Counterpart
2a Recess in the counterpart
3 First seal
3a Valve body
4 Valve seat
5 Second seal
7a, 7b, 7c Fluid channel (sniffer channel)
8 Third seal
9 Welded connection
10 Screw body
10a Peripheral surface
10b Through-holes
10c Flange projection
11 Sensor chamber
12 Gas sensor
A Outflow direction of the leaking gas
E Installation direction

1. A device for connecting a gas-conducting conduit element to a counterpart component, comprising:
at least one screw body, which is configured to be brought into engagement with the counterpart,
a first seal, which is in the form of valve body which is configured to be brought into contact with a valve seat provided on the counterpart, or which is in the form of a flat seal, and
a second seal, which operates on a sealing effect principle according to which the sealing effect is exerted irrespective of an axial displacement, which is necessary for creating the sealing effect of the first seal (3).

2. The device according to claim 1, wherein the first seal is formed as a metal seal or curved-surface seal, and/or the second seal is formed as a radial seal, a resilient seal, an O-ring, a delta ring, a liquid seal and the like, and/or the second seal is disposed after the first seal in an outflow direction (A) of a gas flowing out from the gas-conducting conduit element which is leaking through the first seal.

3. The device according to claim 1, wherein the valve body at least partially has a conical shape, rounded shape, spherical shape or globular shape, and/or the valve seat provided in the counterpart has a tapered shape.

4. The device according to claim 1, wherein the first seal is formed on an end face of the screw body and/or the second seal is provided or formed on a peripheral surface of the screw body.

5. The device according to claim 1, wherein the valve body and the valve seat are formed in such a way that an annular contact surface is formed, wherein a central axis of the valve seat and a central axis of the valve body are disposed parallel to one another, and the valve body is displaceable parallel to the two central axes.

6. The device according to claim 1, further comprising at least one fluid channel having an open end which is provided between the first seal and the second seal and which is configured to detect a gas flowing out from the gas-conducting conduit element which is leaking through the first seal.

7. The device according to claim 6, wherein the at least one fluid channel is formed in the screw body and/or in the counterpart.

8. The device according to claim 1, wherein the device, is configured to perform a purely translatory movement, during the creation of the gas-tight connection between the screw body and the counterpart.

9. The device according to claim 1, wherein the screw body is provided with at least two, through-holes for receiving fastening screws, wherein the through-holes are provided on a flange projection of the screw body, and the through-holes are disposed behind the two seals in an outflow direction (A) of a gas flowing out from the gas-conducting conduit element which is leaking through the first seal.

10. The device according to claim 1, further comprising a third seal, which is formed as a radial seal, a resilient seal, an O-ring, a delta ring, or a liquid seal, wherein the third seal is disposed after the first seal or after the second seal in an outflow direction of a gas flowing out from the gas-conducting conduit element which is leaking through the first seal.

11. The device according to claim 1, further comprising a second fluid channel having an open end which is provided between the second seal and the third seal and which is configured to detect a gas flowing out from the gas-conducting conduit element which is leaking through the first seal and through the second seal.

12. The device according to claim 1, wherein the gas-conducting conduit element is connected in a gas-tight manner to the screw body by way of a welded connection.

13. The device according to claim 1, wherein in the sealed state the valve body of the first seal is pressed against the valve seat formed in the counterpart via a screw connection.

14. The device according to claim 1, wherein the valve body, and/or the valve seat is made from a metal, wherein the valve seat is made of a harder material than the valve body.

15. The device according to claim 1, wherein the at least one fluid channel, is channelled into a common sensor chamber in which a gas sensor for detecting gas is disposed.

16. A method for connecting a gas-conducting conduit element to a counterpart, using the device according to claim 1, comprising:
inserting a screw body into a complementarily formed recess of the counterpart,
tightly screwing the screw body to the counterpart by means of a screw connection, wherein
a first seal is brought into a sealed state by pressing a valve body of the first seal against a valve seat provided in the counterpart, and
a second seal, which operates on a sealing effect principle according to which the sealing effect is exerted irrespective of an axial displacement, which is necessary for creating the sealing effect of the first seal, is brought into a sealed state, between the screw body and the recess.

17. The method according to claim 16, further comprising a leakage detection step, wherein an open end of a fluid channel is disposed between the first seal and the second seal and the other end of the fluid channel opens into a sensor chamber in which a gas sensor is disposed;
if now a leak is present at the first seal, the leaking gas flowing or leaking out from the first conduit element flows into the fluid channel and through this into the sensor chamber, wherein
the gas sensor detects the gas, flowing into the sensor chamber and thus detects a leak at the first seal.

18. The device according to claim 1, wherein the gas-conducting conduit element is a hydrogen-conducting conduit element.

19. The device according to claim 1, wherein the valve body is configured to be brought into gas-tight contact with the valve seat.

20. The device according to claim 4, wherein the screw body is a cylindrical screw body.
